(19) United States
(12) Patent Application Publication
(10) Pub. No.: US 2026/0037532 A1
(43) Pub. Date: Feb. 5, 2026

(54) Method for Extracting, Transforming and Loading legal information onto autonomous agents using large language models and computer graph databases

(71) Applicant: Verses AI, Inc, New Westminster, (CA)

(72) Inventors: Axel Constant Pruvost, Montreal (CA); Alessandro Muzzi, Montecchio Emilia (IT); Alexander Kiefer, Arverne, NY (US); Don Moody, Las Vegas, NV (US); Sylvain Pronovost, LaSalle (CA)

(21) Appl. No.: 19/043,493

(22) Filed: Feb. 2, 2025

Related U.S. Application Data
(60) Provisional application No. 63/549,994, filed on Feb. 5, 2024.

(51) Int. Cl. G06F 16/25; G06F 16/901

(52) U.S. Cl. CPC G06F 16/254; G06F 16/9024

(57) ABSTRACT

In a method for extracting, transforming and loading legal information onto autonomous agents, large language models are used to extract decision paths from legal data, a transform method converts the decision paths into a computation graph database known as a factor graph document database, a load method loads factual data onto the factor graph document database using read and write operations, and a decision method infers the decision to be performed by the agent using the mathematical, statistical, and logical capabilities of the factor graph document database.

### BACKGROUND

Extract, Transform, and Load (ETL) operations allow combining multiple sources of data into a single database that can be used for mathematical and statistical operations (e.g., data analytics, predictive modelling, decision making algorithm, etc.). ETL operations allow artificial intelligence (AI) agents to keep the database on which they perform inference, up to date. Within the context of autonomous devices and legal data (e.g., cars, drones, IoT devices, etc.), an ETL system aims at informing the decisions that AI agents have to make, and makes sure that those decisions conform to existing regulation. For instance, if a driver in California wants to operate an autonomous car, in order to start, the car should make sure that the driver conforms to rules of the California Vehicle Code with regards to autonomous cars.

Existing ETL systems are limited in their ability to extract, transform and load legal information onto an AI system. Methods have been used to present and clarify the logical structure of the law, as discussed in Allen, L. E. & Engholm, C. R. Normalized Legal Drafting and the Query Method. Legal Education 29, 380-412 (1978), Sergot, M. J. et al. The british nationality act as a logic program. Commun. ACM 29 (5), 370-386 (1986), Walker, V. R. A default-logic paradigm for legal fact-finding. Jurimetrics 47, (2006), and to illustrate how statistical inference may be performed using such logical structure, as discussed in Constant, A. A Bayesian model of legal syllogistic reasoning. Artificial Intelligence and Law (2023) doi:10.1007/s10506-023-09357-8. Extracted logical structures have been used to create decision paths that allow users to discover, based on a series of questions, what may be the outcome of the user's legal situation (see Westermann, H. & Benyekhlef, K. Justicebot: A methodology for building augmented intelligence tools for laypeople to increase access to justice. ICAIL 351-360 (2023)). However, none of this provides a complete ETL system that would allow an AI agent to autonomously make decisions based on legal information (e.g., refusing to start the engine if the criteria establishing the California Vehicle Code are not met).

### SUMMARY OF THE INVENTION

According to the invention, there is provided a method for extracting, transforming and loading legal information onto autonomous agents using large language models and computer graph databases by loading legal information onto a database that can be used to perform AI agent decision making using mathematical, logical and statistical operations. The method includes using large language models (LLMs), as defined below, to extract logical decision paths from legal text, and transform the logical decision paths into a factor graph document database (see definition below) that stores legal data (e.g., information from statutes) and factual data (e.g., information about facts of the world that are covered by the statutes). The factor graph document database is a form of computer graph database (see definition below) that can perform mathematical, statistical and logic-based inference on the information stored in the database.

Thus, according to the invention there is provided a method of extracting, transforming, and loading legal information to drive the decisions of an autonomous artificial intelligence agent, comprising, extracting a logical structure from the legal information, wherein the natural legal information corresponds to jurisprudential, statutory, or regulatory texts, transforming the logical structure of the legal information into a formal representation of the logical structure of the legal information, wherein the formal representation is a decision path defined by one or more decision points, transforming the formal representation of the logical structure of the legal information into a factor graph document database with source nodes, destination nodes, and edges capable of performing mathematical, logical and statistical operations over the source and destination nodes, using a computer program, loading elements of a fact pattern onto the factor graph document database by updating conditional probabilities that map destination nodes onto elements of the fact pattern, wherein the update of the conditional probabilities is done using a method of adding count and normalizing the conditional probability mapping, implementing the factor graph document database into the software of an artificial intelligence agent using a computer program, and inferring a decision to be enacted by the autonomous artificial intelligence agent using the factor graph document database by inferring all posterior probabilities of the value of all destination nodes and all the logical statements, wherein the inference of the decision is done using a computer program.

The formal representation of the logical structure of the legal information may correspond to cumulative or disjunctive legal criteria established by the legal data.

The legal data may be extracted using a Large Language Model (LLM) based on a series of engineered prompts that are applied as input to the LLM, and wherein the formal representation of the logical structure corresponds to a legal decision path as known in the arts.

The transforming of the logical structure of the legal information into a formal representation of the logical structure of the legal information may be achieved in the factor graph document database by turning the cumulative or disjunctive criteria into one or more destination nodes of the factor graph document database, or into one or more source nodes of the factor graph document database, and by adding to each source node a destination node corresponding to a decision outcome.

The edges of the factor graph document database are typically structured so that they are capable of computation, encode conditional probabilities, which relate elements of a fact pattern encoded by one or more destination nodes or one or more source nodes, to legal criteria encoded by one or more destination nodes or one or more source nodes, and wherein logical gates connecting one or more source and one or more destination nodes correspond to the legal criteria.

The values of the destination nodes representing the decision outcomes may be inferred using the factor graph document database, wherein the inference may be done by progressing through the logic of the one or more decision points defined by the source nodes and destination nodes of the factor graph document database implementing the legal criteria.

The updating of the conditional probabilities mapping the elements of the fact pattern to the legal criteria may be done using read and write operations through any transaction protocol that allows a client to operate Create, Read, Update, and Delete (CRUD) operations.

### BRIEF DESCRIPTION OF THE DRAWINGS

FIG. 1 is a depiction of the structure of a simple prior art graph database as known in the art;

FIG. 2 is a depiction of the structure of a computation graph database as known in the art;

FIG. 3 is a depiction of the structure of a factor graph document database treated as a computation graph database, as known in the art;

FIG. 4 illustrates a flowchart of one embodiment of the invention;

FIG. 5 illustrates a decision path for Art 38750 of the California Vehicle Code (CVC) as part of one implementation of the present invention, and

FIG. 6 shows one implementation of a factor graph document database implementing a decision path in accordance with the invention.

### DETAILED DESCRIPTION

### Definitions

### Large Language Model

A Large Language Model (LLM) is part of the class of computational models known as foundation models. Foundation models are computational models that are pre-trained on a large amount of data. LLMs are foundation models that have been trained on text data, specifically (e.g., text files found online). By analogy, an LLM is like a person who would have read and encoded the information coming from a vast amount of texts (e.g., has read many books, websites, etc.) and that could combine the knowledge that she has acquired to respond to various queries (e.g., “what is the color of the sky?”). An LLM is built out of the combination of three elements: (i) text data, (ii) a computational architecture, and (iii) a training process. Depending on the LLM, the computational architecture will differ. For instance, for well-known LLMs such as GPT-3, the computational architecture used is a neural network that has a transformer architecture. Transformer architectures perform 1-to-many string comparisons (e.g., comparing a sentence to all similar sentences, or more precisely “tokens”) to then generate new sentences that are informed by the syntax of the already known sentences. The process starts with an encoding step that involves: (i) transforming the natural language into token embeddings, which are numerical representations of the words (i.e., strings of numbers), (ii) estimating the normal position of the words and sentences, with respect to one another, which is made possible by the conversion of the words into their numerical equivalent (e.g., “The” comes before “sky”), (iii) tracking the normal relationship between the words turned into numerical representations using a process called self-attention (e.g., adjectives like “blue” relate to nouns like “sky”, and not articles like “the” when they are positioned before names like “sky”). The encoded sentences can then be used to perform various mathematical operations to further compare the sentences, find similar sentences, predict what words could be used to complete the sentences, find sentences that respond to other sentences, etc. With respect to how LLMs are used in general, and in this invention, text inputs known as “prompts” are used as inputs to the LLM to generate text output that functions as responses to the prompt. Prompts can be questions (e.g., what is the color of the sky?) or imperative statements (e.g., write a computer code that can be implemented to generate sky in a game engine). Prompts are structured in a way that can elicit the desired response—similar to how one would structure a question posed to humans so as to elicit a certain response. The activity of engineering a prompt to elicit the desired response is called “prompt engineering”. In summary, LLMs are used as tools for responding to natural language queries, just like calculators may be used for responding to a query in mathematical language (e.g., “what is 2+2?”). Prompt engineering is the activity of asking the right question to an LLM (e.g., asking “what is 2+2” when looking for an addition instead of asking “what is 2×2”). An LLM is a foundation model trained on text data that takes as input an engineered text “prompt”, and processes that prompt to generate an output, which is the response that corresponds to the prompt. This invention is not limited to the use of LLMs based on transformer neural networks, but includes LLMs in general. The claimed method covers any computer system able to receive a prompt-like input and generate the appropriate response to the prompt.

### Factor Graph Document Database

Databases are queryable data stores. The three common classes of databases are relational databases, graph databases, and vector databases. Compared to relational and vector databases, graph databases store data in a way that allows for querying by looking at parent-child relationships between the stored entities (e.g., “give me the child entities to the Steve entity”). Graph databases can represent entities in the world and the relationships between them. Entities are any physical or conceptual “thing” that has meaning in the real world (e.g., a robot, a sofa, a waypoint in space that refers to a location where one can go, a specification of an activity, etc.). Relationships between entities are expressed as edges that connect source nodes (e.g., the parent or cause nodes) and the destination nodes (e.g., the children or the consequence node), and that can give cause-consequence, or parent-child information.

A vector graph document database is a queryable data store. Vector graph document databases are databases whose structure allows for mix queries combining relational, graph, and vector databases type queries (e.g., “give me the products whose prices are greater than 5 dollars and that are sold by the company X, and whose description best matches that of sunglasses”).

A computation graph database is a graph database for a computation graph. The computation graph is a directed graph, which includes source and destination nodes that represent variables, and further includes edges representing transformations in the value of a destination node that can occur when an update happens to a connected source node. The terms “entity”, “node” and “variable” are used interchangeably. A computation graph database is thus a graph database that can be used to perform mathematical operations over the stored entities.

A factor graph is a type of probabilistic graphical model that can be used to perform inferences over the entities represented by the nodes in the graph. A factor graph consists of two types of nodes: (i) factor nodes, which represent factors or functions that relate multiple variables together (e.g., the function that multiplies the elements x1,x2,x3 . . . of a variable X with the elements y1,y2,y3 . . . of a variable Y), (ii) and variable nodes, which represent the variables in the model. For the factor graphs used in this invention, we use a bipartite graph representation and partition the graph into factor nodes and variable nodes. The factor nodes are connected to the variable nodes that they depend on, and the graph structure reflects the conditional dependencies between the variables. Variable nodes are denoted by circles and correspond to variables over which the inference algorithm applies. Variable nodes are entities of the vector graph document database. Factor nodes are denoted by squares and denote the relation between variables, or entities.

A factor graph document database is a type of computation graph database that uses a factor graph to implement a vector graph document database over which factor graph operations such as message passing can be performed. Factor graph operations allow the inference of values of any desired nodes in the vector graph document database. Thus, factor graph document databases are computation graph databases structured as factor graphs, and that are able to perform factor graph operations such as message passing.

In one embodiment of the present invention, the code for the claimed method is implemented as a class in the Python programming language and is composed of an extract method that converts legal data into decision paths as known in the arts (Janatian, S., Westermann, H., Tan, J., Savelka, J. & Benyekhlef, K. From Text to Structure: Using Large Language Models to Support the Development of Legal Expert Systems. arXiv [cs.CL] (2023)) a transform method that converts the decision path into a computation graph database known as a factor graph document database, a load method that loads factual data onto the computation graph that implements the factor graph document database, using read and write operations that are performed through any transaction protocol allowing a client to operate Create, Read, Update, and Delete (CRUD) operations, and a decision method that infers the decision to be performed by the agent using the mathematical, statistical, and logical capabilities of the factor graph document database.

By way of example, an implementation of the present invention may control an autonomous vehicle to ensure compliance with the law in California. Thus, if a person enters an autonomous vehicle and tries to start the vehicle, the vehicle decides autonomously whether to start or not, based on article 38750 b), DIVISION 16.6. Autonomous Vehicles [38750-38755] of the California Vehicle Code. If one of the conditions of use of the autonomous vehicle is not met, the vehicle may decide to stop or, depending on the circumstances, alert authorities.

For instance, the California Vehicle Code may state that:
(b) An autonomous vehicle may be operated on public roads for testing purposes by a driver who possesses the proper class of license for the type of vehicle being operated if all of the following requirements are met:
(1) The autonomous vehicle is being operated on roads in this state solely by employees, contractors, or other persons designated by the manufacturer of the autonomous technology.
(2) The driver shall be seated in the driver's seat, monitoring the safe operation of the autonomous vehicle, and capable of taking over immediate manual control of the autonomous vehicle in the event of an autonomous technology failure or other emergency.
(3) Prior to the start of testing in this state, the manufacturer performing the testing shall obtain an instrument of insurance, surety bond, or proof of self-insurance in the amount of five million dollars ($5,000,000), and shall provide evidence of the insurance, surety bond, or self-insurance to the department in the form and manner required by the department pursuant to the regulations adopted pursuant to subdivision (d).

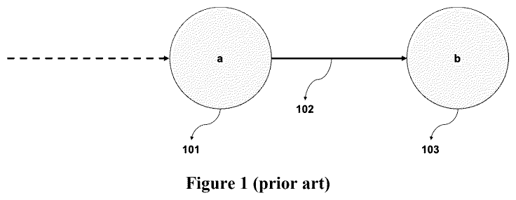

FIG. 1 illustrates the structure of a simple prior art graph database with two nodes: source node 101, and destination node 103, related to each other by an edge 102. A graph database gives parent-child information about the entities (which are defined by the nodes) contained in the database. The graph database represents parent-child information by using edge 102 relating the source entity 101 and the destination entity 103.

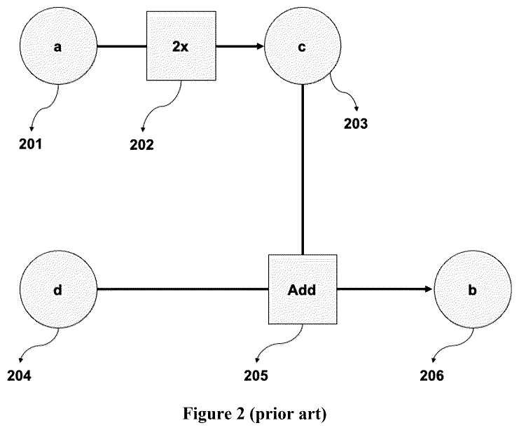

FIG. 2 illustrates the structure of a prior art computation graph database performing a mathematical operation “b=2a+d” over the source node “a” and a destination node “b”. The update rule is represented as a mathematical operation whose description is encoded in the graph database (e.g., operations represented as squares in FIG. 2 operating on factor nodes and intermediary nodes) and operated through a call to a programming language. In FIG. 2, this is defined by source node a (201) being subjected to a multiplication operation 202 to define interim node 203. Node d (204) is added by “Add” operation 205 to the value of interim node 203 to define destination node b (206). The function of a computation graph database is to update a destination node (e.g., b) when a change in a source node (e.g., a) happens. When a change in entity a (201) is observed, the value of the entity b (206) is updated. The update rule is operated through two transforms, which are transform 202, which calculates two times the value of a (2a) to define variable c 203, and transform 205, which adds variable c to variable d 204 to update variable b 206. This operation thus requires an intermediary entity c 203 that is constructed for the purposes of evaluating the expression operated by the transform in 205.

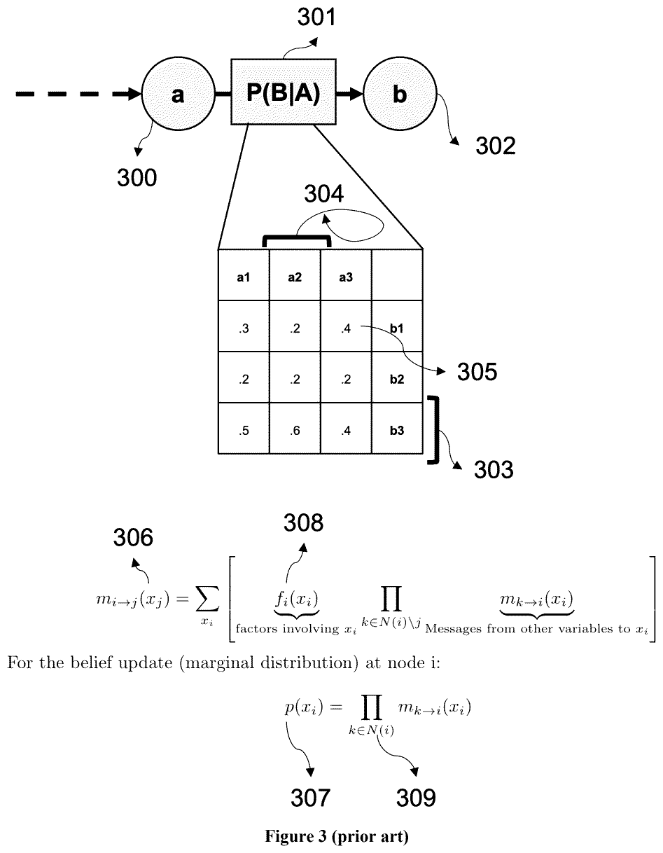

FIG. 3 shows the structure of a factor graph document database treated as a computation graph database. As a type of computation graph database, a factor graph database can perform operations such as message passing to update the variables stored in the database. The factor graph relates a source node a (300) and a destination node b (302), and their relating factor encoding information 301 about the conditional probability of elements of the variable b relating to elements of the variable a. The probabilities are presented as mappings in matrices (or in tensors). 304 indicates that the column of the matrix corresponds to a probability distribution (i.e., must sum to 1, e.g., 0.2+0.2+0.6). Each cell encodes a probabilistic mapping between the variable represented by the column (e.g., elements of a such as a1, a2, a3) and the variable represented by the rows (e.g., elements of the variable b such as b1, b2, b3). Reference numeral 303 indicates the rows that represent the observed variable, or the children of an entity. Reference numeral 305 indicates that the probability of b1 being related to a3 is 40% (0.4). The mathematical operation performed by the factor graph database is an inference algorithm represented in the equation (306-309). The algorithm is a message-passing algorithm that computes the message from node i (e.g., a) to node j (e.g., b). The message is defined as the summation of the product of the factor at the node of interest and of the messages coming from other variable nodes, over all possible values of the entity i as encoded by the link 306, N(i) referring to the set of neighboring nodes. 307 is the marginal probability of node i, 308 is the factor associated with node i, and 309 is the set of neighbors of node i. The inference method of the present invention uses a factor graph document database. The factor graph document database can also be trained directly based on observations using a method of updating by counts, which uses a computer program to add, for instance “+1” to a cell of the matrix that constitutes the factor. For instance, if a cell contains “0.4” (305), adding a count to the cell would mean raising the value of the cell to 1.4 (1+0.4). If the cell is part of a column that has three cells in total, which together form a distribution (e.g., 0.4, 0.2, 0.4,), then the column after the updated count would be “1.4; 2; 4”. The column gets renormalised such that its three cells sum to 1 (e.g., 1.4 becomes 0.7, 0.2 becomes 0.1, and 0.4 becomes 0.2). This method of adding counts trains the factor graph document database using observed data by adding +1 after observing the co occurrence b1 and a3, which augments the probability of P (b1|a3) in the factor graph to 0.7 and decreases the probability of the two other mappings of the column, bringing them down to 0.1 for P(b2|a3) and 0.2 for P(b3|a3).

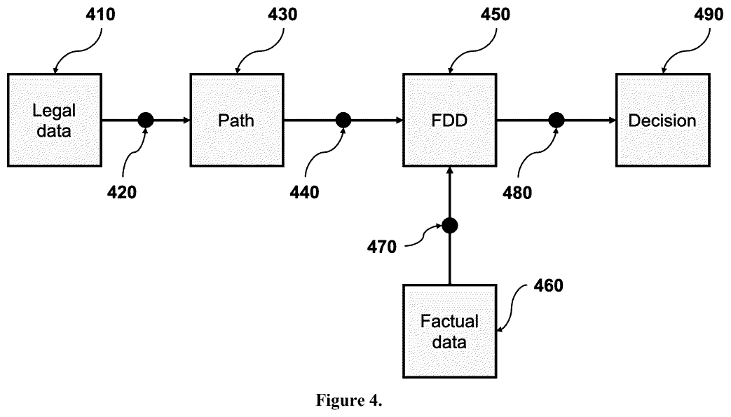

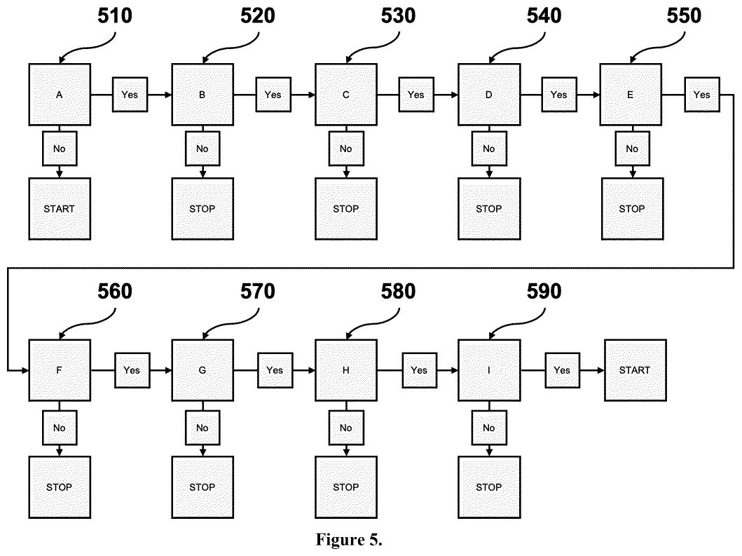

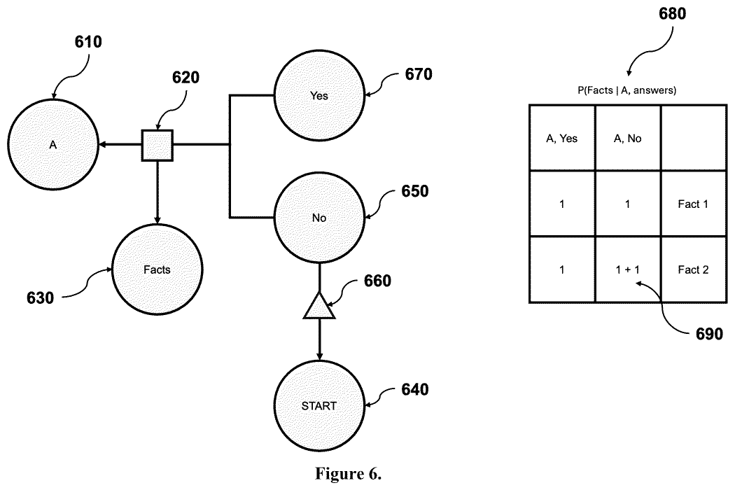

FIG. 4 illustrates a flowchart of one embodiment of the invention. Legal data (e.g., Article 38750 of the California Vehicle Code (CVC) (410) is converted into a decision path (430) using an extract method (420) that uses methods of conversion known in the arts (Janatian, S., Westermann, H., Tan, J., Savelka, J. & Benyekhlef, K. From Text to Structure: Using Large Language Models to Support the Development of Legal Expert Systems. arXiv [cs.CL](2023)) that pass an engineered prompt and legal data (e.g., PDF of legal text) to a LLM to extract a decision path. The decision path is converted into a factor graph document database (FDD) (450) using a transform method (440) as discussed in more detail with respect to FIG. 6. A load method (470) (discussed further below) is used to load factual data (460) onto the factor graph document database (450). The loading is done by updating the counts in the parameters of the factor graph database as discussed in more detail with respect to FIG. 5. Updating the counts can be done automatically or manually, based on information already available to the agent (e.g., license information available from the autonomous car's software), or available from the user (e.g., a user having to validate credentials before driving the autonomous vehicle). A decision method (480) is used to infer the decision (490), i.e., whether the agent can perform the action (e.g., whether the autonomous vehicle should start or not).

Legal text often defines actions that are permissible or not permissible, thereby defining a logical structure (e.g., “You may not cross on a red traffic light” being logically equivalent to the logical statement “if cross on a red traffic light, then you are liable”, wherein the term “then” stands for the material implication in propositional logical symbolised as “-->”). FIG. 5 illustrates a decision path for Art 38750 of the CVC. The extract method is implemented as a program known in the art that uses a LLM to convert legal data into decision paths using expert systems and programming language as known in the art (Westermann, H. & Benyekhlef, K. Justicebot: A methodology for building augmented intelligence tools for laypeople to increase access to justice. ICAIL 351-360 (2023) and Janatian, S., Westermann, H., Tan, J., Savelka, J. & Benyekhlef, K. From Text to Structure: Using Large Language Models to Support the Development of Legal Expert Systems. arXiv[cs.CL](2023)). The decision path is obtained from the extract method that is applied to the legal data, for instance, to Art 38750 of the CVC, as is illustrated in FIG. 5. The decision path functions as a representation of the logical structure of the legal information, or text. The decision path represents the legal information which may contain one or more legal criteria, wherein the application of the rule described by the legal information may require compliance with two or more of the criteria (cumulative) or compliance with only one of the criteria (disjunctive). The decision paths can be described as follows:
A. Is the autonomous vehicle operated on public roads for testing purposes? (510)
   Yes, then move to B.
   No, then start
B. Is the autonomous vehicle operated by a driver? (520)
   Yes, then move to C
   No, then stop
C. Does the driver possess the proper class of licensing? (530)
   Yes, then move to D
   No, then stop
D. Is the vehicle being operated by a person that is not an employee, a contractor, by a designated person? (540)
   Yes, then move to E
   No, then stop
E. Is the driver seated in the driver's seat? (550)
   Yes, then move to F.
   No, then stop
F. Is the driver monitoring the safe operation of the autonomous vehicle? (560).
   Yes, then move to G
   No, then stop
G. Is the driver capable of taking over immediate manual control of the autonomous vehicle? (570)
   Yes, then move to H
   No, then stop
H. Is the manufacturer performing the testing covered by an insurance, surety bond, or self-insurance in the amount of five million dollars ($5,000,000)? (580)
   Yes, then move to I
   No, then stop
I. Has the manufacturer provided evidence of the insurance, surety bond, or self-insurance to the department in the form and manner required by the department pursuant to the regulations adopted pursuant to subdivision (d)? (590)
   Yes, then start
   No, then stop

In accordance with the invention, a decision path can be implemented in the form of a factor graph document database that defines the various decision points in the decision path. FIG. 6 depicts a factor graph document database implementing a decision path for the first decision point (reference numeral 510) in FIG. 5. A factor graph is generated to integrate all the decision points. The factor graph document database is obtained using the transform method, which is implemented as a computer program using a programming language. The transformation from the decision path to the factor graph document database is achieved using a programming language, by turning each node of the decision path corresponding to the cumulative of disjunctive criteria of a rule (510) into a destination node (610), and by adding a destination node for the legal fact referred to by the rule (630), for instance, the fact concerning whether the car is on a “public road”, as well as a destination node for the action that may be allowed depending on the fact at hand (e.g., “start”, 640), and by turning the decision nodes of the decision paths (e.g., yes and no nodes) into source nodes (670 and 650). In this way, a fact pattern is loaded onto the factor graph document database to deal with a particular fact scenario. The factor graph document database, as described in FIG. 3, is made of nodes and factors. Because it is a computation graph, it can include additional operations such as logical operations. The node A (610) represents the first question of the decision path (i.e., “Is the autonomous vehicle operated on public roads for testing purposes?”). The factor node (620) encodes the joint probability of the question (e.g., question “A”) and its possible answers (e.g., “Yes” or “No”), conditional upon the loaded facts represented as a variable node (630) (e.g., geolocalisation information about where the vehicle is and information about the activity of the driver). The matrix that constitutes the factor node designated with reference numeral 620 is depicted in reference numeral 680 that encodes the conditional distribution “P (Facts| A, answers)”. Based on the facts, the counts in the factor node will be updated by adding “+1” (690) (method of adding count). For instance, if the facts suggest that the vehicle is not operated on a public road for testing purposes, the car will infer the “no” variable node (650) and may authorise the driver to start (640) the car without checking the other conditions coded by the rules being modeled (e.g., conditions B,C,D,E,F,G,H,I of FIG. 5). The inference is done using the decision method that uses the message passing algorithm described in reference numeral 306-309. The decision is enabled by the inference of the answer to the question based on the loaded fact and operated by a logical gate (660) which returns “START” when “No” is true. If the facts suggest that the driver is on public road for testing purposes (i.e., if the inference based on facts returns “yes”), then the other conditions are checked in the same way.

While the present invention has been described with respect to specific examples and implementations, it will be appreciated that the invention is not so limited but instead can be implemented for different purposes as defined by the Claim and Summary of the Invention.

What is claimed is:

1. A method of extracting, transforming, and loading legal information to drive the decisions of an autonomous artificial intelligence agent, comprising,
extracting a logical structure from the legal information, wherein the natural legal information corresponds to jurisprudential, statutory, or regulatory texts,
transforming the logical structure of the legal information into a formal representation of the logical structure of the legal information, wherein the formal representation is a decision path defined by one or more decision points,
transforming the formal representation of the logical structure of the legal information into a factor graph document database with source nodes, destination nodes, and edges capable of performing mathematical, logical and statistical operations over the source and destination nodes, using a computer program,
loading elements of a fact pattern onto the factor graph document database by updating conditional probabilities that map destination nodes onto elements of the fact pattern, wherein the update of the conditional probabilities is done using a method of adding count and normalizing the conditional probability mapping,
implementing the factor graph document database into the software of an artificial intelligence agent using a computer program, and
inferring a decision to be enacted by the autonomous artificial intelligence agent using the factor graph document database by inferring all posterior probabilities of the value of all destination nodes and all the logical statements, wherein the inference of the decision is done using a computer program.

2. A method of claim 1, wherein the formal representation of the logical structure of the legal information corresponds to cumulative or disjunctive legal criteria established by the legal data.

3. A method of claim 2, wherein the legal data is extracted using a Large Language Model (LLM) based on a series of engineered prompts that are applied as input to the LLM, and wherein the formal representation of the logical structure corresponds to a legal decision path as known in the arts.

4. A method of claim 2, wherein the transforming of the logical structure of the legal information into a formal representation of the logical structure of the legal information is achieved in the factor graph document database by turning the cumulative or disjunctive criteria into one or more destination nodes of the factor graph document database, or into one or more source nodes of the factor graph document database, and by adding to each source node a destination node corresponding to a decision outcome.

5. A method of claim 4, wherein the edges of the factor graph document database that are capable of computation, encode conditional probabilities, which relate elements of a fact pattern encoded by one or more destination nodes or one or more source nodes, to legal criteria encoded by one or more destination nodes or one or more source nodes, and wherein logical gates connecting one or more source and one or more destination nodes correspond to the legal criteria.

6. A method of claim 5, wherein the values of the destination nodes representing the decision outcomes are inferred using the factor graph document database, wherein the inference is done by progressing through the logic of the one or more decision points defined by the source nodes and destination nodes of the factor graph document database implementing the legal criteria.

7. A method of claim 1, wherein updating of the conditional probabilities mapping the elements of the fact pattern to the legal criteria is done using read and write operations through any transaction protocol that allows a client to operate Create, Read, Update, and Delete (CRUD) operations.
